(19) United States
(12) Patent Application Publication
(10) Pub. No.: US 2014/0116964 A1
(43) Pub. Date: May 1, 2014

(54) METHOD AND SYSTEM FOR DISPOSING OF DRILL CUTTINGS

(71) Applicant: CLEAN HARBORS ENVIRONMENTAL SERVICES, INC., Norwell, MA (US)

(72) Inventors: Travis Griffin Bevan, South Williamsport, PA (US); Timothy Albert Rich, Watsontown, PA (US); Justin Michael Roberts, Plum, PA (US); Jonathan Michael Smith, Williamsport, PA (US)

(73) Assignee: Clean Harbors Environmental Services, Inc., Norwell, MA (US)

(21) Appl. No.: 13/663,974

(22) Filed: Oct. 30, 2012

(51) Int. Cl. B01D 33/01; B01D 37/00

(52) U.S. Cl. CPC B01D 33/0183; B01D 37/00
USPC 210/780; 210/806; 210/787; 210/258; 210/767

(57) ABSTRACT

A method and apparatus for disposing of drill cuttings includes collecting drilling mud from a wellbore, the drilling mud comprising liquid and solids, separating the liquid from the solids in a first separation step, separating the liquid from the solids in a second separation step, and transferring the solids to a container with a vacuum pump.

### BACKGROUND OF THE INVENTION

1. Field of the Invention

Embodiments of the invention generally relate to removing solids from liquid. More particularly, embodiments of the invention relate to a method and system for disposing of drill cuttings from drilling fluids.

2. Description of the Related Art

Drilling rigs are used to extract oil, gas, and other hydrocarbons from sub-surface formations. A drill string is typically lowered down hole, and a drill bit at the end of the drill string is rotated to cut into the mineral deposits in the sub-surface formations. Drilling fluid, such as drilling mud, is pumped through the drill bit during the drilling operation to help facilitate the drilling process, and the drilling mud with cuttings from the wellbore are circulated back up to the surface in an annular area formed between walls of the wellbore and the drill string where the mud is separated from the cuttings for re-use.

Various methods and systems are used to remove and dispose of drill cuttings, but they are inefficient and/or produce unwanted waste at a work site. Therefore, there is a need for improved methods and systems of disposing of drill cuttings that overcomes the present issues.

### SUMMARY OF THE INVENTION

In one embodiment, the invention includes a method for disposing of drill cuttings that includes collecting drilling mud from a wellbore, the drilling mud comprising liquid and solids, separating the liquid from the solids in a first separation step, separating the liquid from the solids in a second separation step, and transferring the solids to a container using a vacuum pump.

In one embodiment, the invention includes a system used to dispose drill cuttings comprising a first shaker, a second shaker, a vacuum pump, and a removable container. Drilling mud, which contains liquid and solids, is passed through the first and second shakers to separate the liquid from the solids, and the vacuum pump moves the solids to the removable container.

In one embodiment, the invention includes a method of disposing of drill cuttings comprising collecting drilling mud from a wellbore, the drilling mud comprising liquid and solids, separating the solids from the liquid, and transferring the solids to a container with a vacuum pump.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a system for disposing of drill cuttings according to one embodiment of the invention;

FIG. 2 is a flow chart illustrating steps for disposing of drill cuttings according to an embodiment of the invention.

### DETAILED DESCRIPTION

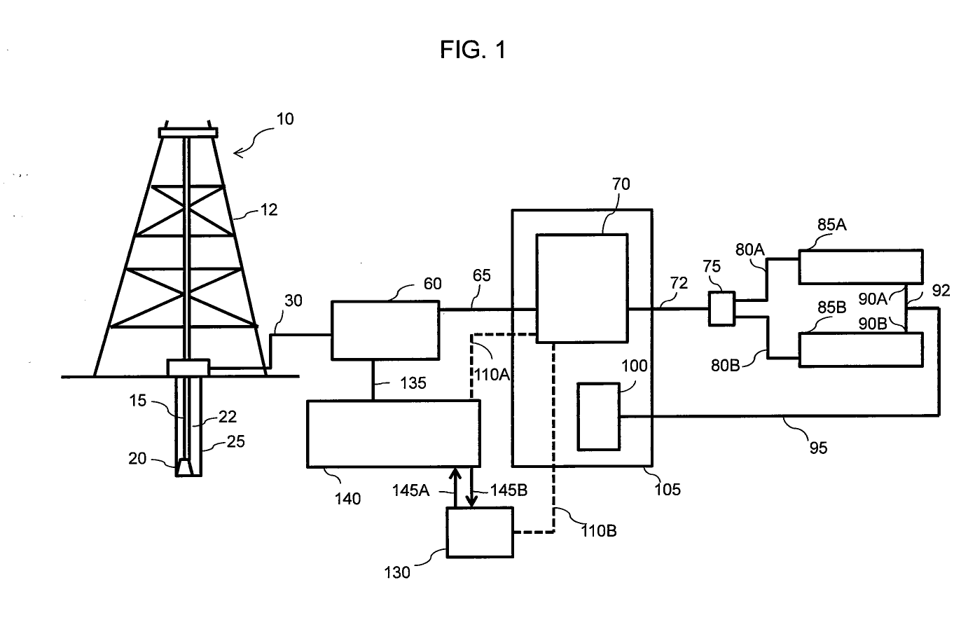

FIG. 1 is a schematic view of a system of disposing of drill cuttings 10 according to one embodiment of the invention. While an onshore well drilling system 10 is described, it is also contemplated that the system and method of disposing of drill cuttings described herein could be used in conjunction with any other drilling system. The well drilling system 10 includes a drill rig 12 supporting a drill string 15. A drill bit 20 is connected to the drill string at a lower end and used to cut into a mineral formation below the surface. A casing 25 surrounds the drill string 15, and an annular area 22 is provided between the drill string 15 and the casing 25. Drilling mud, which may comprise liquid or both liquid and solids, is pumped through the drill string 15 and through the drill bit 20 as the drill bit 20 rotates and cuts through the formation. As a result of this drilling operation, drill cuttings from the formation are produced. The drilling mud being pumped through the drill string 15 and through the drill bit 20 carries the drill cuttings up the annular area 22 to the surface. The drilling mud with drill cuttings is collected at the surface, and then transferred to one or more rig shakers 60, typically by a conduit 30.

The rig shakers 60 include a screen with a basin beneath the screen to collect liquid as it is removed and filtered from the drilling mud with drill cuttings. The rig shakers 60 further include a vibrator for shaking the screen. As the vibrator shakes the screen, additional liquid is removed from the drilling mud and drill cuttings, and the liquid moves to the basin. In one embodiment, the rig shakers are mounted onto rig mud tanks 140, and the liquid removed from the drilling mud and drill cuttings may be allowed to directly filter into the rig mud tanks 140. The drilling mud with drill cuttings remaining on the screen of the rig shakers 60, which will be referred to herein as the first filtered drilling mud, is moved to a discharge chute of the rig shakers 60. The discharge chute of the rig shakers 60 may transfer the first filtered drilling mud directly onto one or more second shakers 70, or a conduit 65 may carry the first filtered drilling mud from the rig shakers 60 to the second shakers 70. Although the drilling mud with drill cuttings is described as being circulated through the rig shakers 60, as is well known in the art, other first filtration methods and apparatus may be used to provide the first filtered drilling mud to the second shakers 70.

In one embodiment, the second shakers 70 may include high gravity shakers, and may include a finer gauge mesh screen (than the rig shakers 60) positioned over a basin for collecting liquid. The second shakers 70 are capable of removing and filtering additional liquid from the first filtered drilling mud, and may isolate the drill cuttings from the first filtered drilling mud. Like the rig shakers 60, the second shakers 70 include a vibrator for shaking the screen, and hence, the liquid in the first filtered drilling mud is removed and filtered into the basin below the screen. The second shakers 70 also include a discharge chute, and as the liquid is removed from the first filtered drilling mud, the remaining drill cuttings and other solids, hereinafter referred to as the remaining drill cuttings, may be moved to the discharge chute of the second shakers 70. The discharge chute allows the remaining drill cuttings to be collected in a collection area, which in one embodiment includes a common low point to facilitate the drill cuttings being directed to one general location. In one embodiment, instead of the remaining drill cuttings moving to the discharge chute of the second shakers 70, the remaining drill cuttings are directly deposited to the collection area.

It is contemplated that the second shakers 70 may include other drying cuttings technology, such as Verti-G or cyclone-type technology. For example, the first filtered drilling mud could be spun until the remaining drill cuttings are separated from the liquid, and the remaining drill cuttings are moved to a discharge chute that moves the remaining drill cuttings to a collection area.

A vacuum conduit 72 is positioned within the collection area, and in one embodiment is positioned in or near the low point of the collection area. The vacuum conduit 72 also extends to and is connected to at least one container 85A. The container 85A is further connected to a vacuum pump conduit 95 that is connected to a vacuum pump 100. The vacuum pump 100 creates suction within the container 85A, and therefore within the vacuum conduit 72, which results in the remaining drill cuttings being transferred to the container 85A through the vacuum conduit 72. An exemplary vacuum pump 100 includes a Triton 1500 Electric Vacuum Pump Skid. The container 85A is an enclosed container and is capable of withstanding suction pressure created by the vacuum pump 100, and is commonly referred to as a vacuum container by those skilled in the art.

In one embodiment, the vacuum conduit 72 may extend to a manifold 75 wherein one or more secondary vacuum conduits 80A, 80B may extend to one or more containers 85A, 85B. In FIG. 1, only two secondary vacuum conduits 80A, 80B and containers 85A, 85B are shown, but it is contemplated that any number of secondary vacuum conduits and containers could be used. The manifold 75 may allow the one or multiple containers 85A, 85B to be filled with drill cuttings at a given time by adjusting the position of one or more valves located within the manifold.

In one embodiment, the vacuum pump conduit 95 may be connected to a vacuum manifold 92 which may allow one or more secondary vacuum pump conduits 90A, 90B to extend to the containers 85A, 85B. In FIG. 1, only two secondary vacuum pump conduits 90A, 90B are shown, but it is contemplated that any number of secondary vacuum conduits could be used. The vacuum manifold 92 may allow the one or multiple containers 85A, 85B to be provided with suction from the vacuum pump 100 at a given time by adjusting the position of one or more valves located within the manifold. In one embodiment, a single manifold may be used to control vacuum suction within secondary vacuum conduits 80A, 80B and to control vacuum return within vacuum pump conduits 90A, 90B.

After the drill cuttings are vacuumed into one or more of the containers 85A, 85B, the containers 85A, 85B may be removed and/or replaced by other like containers. The containers 85A, 85B may be hauled by truck or other transportation, and the drill cuttings contained therein may be recycled or disposed of in a controlled manner.

Optionally, in one embodiment, a liquid conduit 110A may extend from the second shakers 70 to the rig mud tank 140, wherein liquid removed from the first filtered drilling mud may be transferred to the rig mud tank 140. A pump, such as a submersible pump, may be used to move the liquid from the second shakers 70 to the rig mud tank 140. Optionally, in one embodiment, a liquid conduit 110B may extend from the second shakers 70 to one or more centrifuges 130, wherein the liquid is processed further to remove excess particulates and impurities. A pump may also be used to move the liquid from the second shakers 70 to the centrifuges 130. In one embodiment, the liquid processed by the centrifuges 130 may then be transferred to the rig mud tank 140 by a conduit 145A. Furthermore, liquid in the rig mud tank 140 may be transferred by a conduit 145B to the centrifuges 130 for processing, and then moved back to a separate compartment in the rig mud tank 140 via the conduit 145A.

In one embodiment, one or more of the second shakers 70 and/or the vacuum pump 100 may be positioned on a bin 105, and in some instances, may be mounted on the bin 105. In one embodiment, the bin is a low wall shale bin. The bin 105 may provide secondary containment to the second shakers 70 and/or the vacuum pump 100, and the bin 105 may also provide easy transportation for the components contained therein. The bin 105, along with the components therein, may be hauled by truck or other transportation from work site to work site, facilitating ease of the transfer of a large portion of the system for disposing drill cuttings described above.

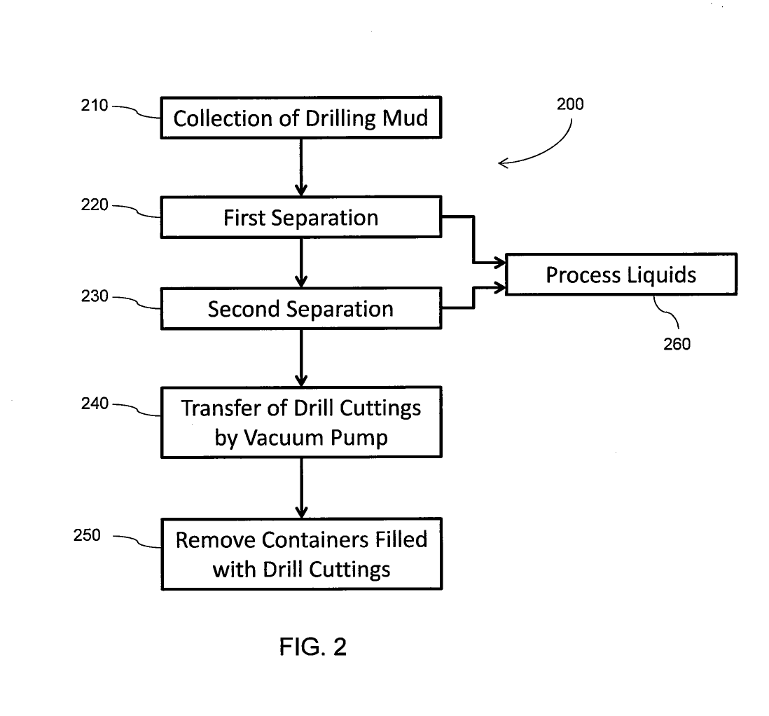

FIG. 2 is a flow chart illustrating steps of a method 200 for disposing drill cuttings according to one embodiment of the invention. In a first step 210, drilling mud carrying drill cuttings is collected from a well drilling system 10. The drilling mud carrying drill cuttings is transferred to one or more rig shakers 60. In a second step 220, liquid is removed from the drilling mud carrying drill cuttings by the rig shakers 60, which leaves a first filtered drilling mud. The first filtered drilling mud is transferred to one or more second shakers 70. In a third step 230, liquid is removed from the first filtered drilling mud, which leaves drill cuttings. In a fourth step 240, the drill cuttings are transferred to one or more containers 85A, 85B by a vacuum pump 100. Optionally, in a fifth step 250, the containers 85A, 85B filled with drill cuttings may be removed from the work site. In addition, the liquid removed during the first and second steps 220, 230 may optionally be transferred to one or more centrifuges 130, wherein the liquid is processed in a sixth step 260. Liquid from the rig shakers 60, second shakers 70, or centrifuges 130 may be collected in a rig mud tank 140.

While the foregoing is directed to embodiments of the invention, other and further embodiments of the invention may be devised without departing from the basic scope thereof, and the scope thereof is determined by the claims that follow.

1. A method of disposing drill cuttings, comprising:
collecting drilling mud from a wellbore, the drilling mud comprising liquid and solids;
separating the liquid from the solids in a first separation step;
separating the liquid from the solids in a second separation step; and
transferring the solids to a container with a vacuum pump.

2. The method of claim 1, wherein a rig shaker is used to separate the liquid from the solids in the first separation step.

3. The method of claim 2, wherein a second shaker is used to separate the liquid from the solids in the second separation step.

4. The method of claim 3, wherein the second shaker is a high gravity shaker.

5. The method of claim 3, wherein a bin holds the second shaker.

6. The method of claim 5, wherein the bin further holds the vacuum pump.

7. The method of claim 1, further comprising processing the liquid removed from the solids using a centrifuge.

8. The method of claim 1, further comprising removing the container filled with solids from a work site.

9. A system used to dispose drill cuttings, comprising:
a first shaker;
a second shaker;
a vacuum pump; and
a removable container,
wherein drilling mud, which contains liquid and solids, is passed through the first and second shakers to separate the liquid from the solids, and the vacuum pump moves the solids to the removable container.

10. The system of claim 9, further comprising a plurality of removable containers and a manifold for directing the solids to one or more of the removable containers.

11. The system of claim 9, further comprising a centrifuge that processes the liquid removed from the drilling mud.

12. The system of claim 9, wherein a bin holds the second shaker and the vacuum pump.

13. A method of disposing of drill cuttings, comprising:
collecting drilling mud from a wellbore, the drilling mud comprising liquid and solids;
separating the solids from the liquid; and
transferring the solids to a container with a vacuum pump.

14. The method of claim 13, wherein a high gravity shaker is used to separate the solids from the liquid.

15. The method of claim 13, further comprising processing the liquid removed from the drilling mud by using a centrifuge.

16. The method of claim 14, further comprising positioning the vacuum pump and the high gravity shaker in one bin.

17. The method of claim 13, wherein the solids are transferred to a plurality of containers with the vacuum pump.

18. The method of claim 17, wherein a manifold is used to direct the solids to one of the plurality of containers.

19. The method of claim 18, wherein a second manifold is used to connect the vacuum pump to one of the plurality of containers.

20. The method of claim 13, further comprising removing the container filled with the solids to a different location.
